(19) United States
(12) Patent Application Publication
(10) Pub. No.: US 2012/0228312 A1
(43) Pub. Date: Sep. 13, 2012

(54) BOTTLE

(76) Inventor: Daniel Sutherland, Newtonhill (GB)

(21) Appl. No.: 13/394,740

(22) PCT Filed: Sep. 7, 2010
(86) PCT No.: PCT/GB10/01692

§ 371 Date: Mar. 29, 2012

(30) Foreign Application Priority Data
Sep. 7, 2009 (GB) 0915509.4
Feb. 16, 2010 (GB) 1002584.9

(51) Int. Cl. A61J 9/00; B65D 25/00

(52) U.S. Cl. 220/669; 215/11.1

(57) ABSTRACT

A bottle for feeding an infant is described. The bottle comprises a body portion adapted to be attachable to a feeding teat, the body portion having a perimeter around either at least one longitudinal section or at least one transverse section which is convoluted.

### FIELD OF THE INVENTION

The present invention relates to an improved bottle. Particularly the present invention relates to an improved bottle for feeding an infant.

### BACKGROUND TO THE INVENTION

Bottles are widely used for feeding infants during the early stages of their life. Generally the bottles are used to feed the infant with either formula milk or breast milk. It is extremely important the milk is supplied to the baby at a temperature which the baby finds acceptable, generally within a few degrees of body temperature.

Preparing a feed using a milk formula is commonly done by mixing the required volume of formula powder with boiling water heated in a kettle or pan in order to minimise the risk of bacterial contamination. As a result of this heating process it is necessary for the prepared feed to be cooled to an acceptable temperature as stated above. This is generally done by immersing the bottle of boiling liquid in a bath of cool water. Pre-prepared milk is generally stored in a refrigerator prior to use, the refrigerated milk has to be heated up when required. This is most commonly done by heating the refrigerated bottle of milk in a microwave, however great care has to be taken with this approach as microwaves do not heat consistently and the body of milk can have pockets of very hot milk contained therein.

An alternative method of heating the milk is to partially immerse the bottle in a bath of hot water.

When immersed in a bath of colder or hotter liquid, a boundary layer forms within the milk, around the internal surface of the bottle. The milk in the boundary layer is at or near the temperature of the water in the bath. Once the boundary layer has formed, the heat transfer from the main body of the milk is reduced, slowing down the heating or cooling process. This problem can be resolved by agitating the bottle to prevent formation of a boundary layer, however unless an automated system is used, this is not a very practical use of the person's time.

### SUMMARY OF THE INVENTION

According to a first aspect of the present invention there is provided a bottle for feeding an infant, the bottle comprising:
a body portion adapted to be attachable to a feeding teat, the body portion having a perimeter around either at least one longitudinal section or at least one transverse section which is convoluted.

By providing a convoluted perimeter in at least one embodiment of the invention, the length of the perimeter and, hence, the surface area of the bottle is increased. An increased surface area of the bottle can lead to the formation, in use, of a larger volume boundary layer, when compared to a bottle of a similar volume with a non-convoluted surface. As the volume of the boundary layer increases, the volume of the body of the milk that is outwith the boundary layer decreases, meaning that a larger proportion of the milk is cooled or heated when immersed into water than is the case with the conventional bottle.

For the avoidance of doubt, the longitudinal section is taken through an axis parallel or coincidental with the direction of flow of milk from the bottle when in use with a feeding teat. The transverse section is taken perpendicular to this axis.

In one embodiment the body portion defines an outlet.

The outlet may lie in a plane.

The plane may be perpendicular to a bottle axis.

The longitudinal section may be perpendicular to the outlet plane.

The bottle axis may lie on the longitudinal section.

The transverse section may be parallel to the outlet plane.

The bottle axis may be perpendicular to the transverse section.

In one embodiment, the height of the bottle is no more than fifty percent bigger or smaller than the maximum width of the bottle. Providing a convoluted surface profile allows the surface area to be increased without increasing the ratio of the height of the bottle to the width of the bottle significantly.

In one embodiment the height of the bottle is approximately equal to the maximum width of the bottle.

In one embodiment the distance of any given point on the section from the section perimeter is less than fifty percent of the maximum width of the section.

In one embodiment the distance of any given point on the section from the section perimeter is less than thirty percent of the maximum width of the section.

Where the section is a transverse section, the length of the perimeter is greater than (πD) where D is the maximum width of the section.

Where the section is a longitudinal section, the length of the perimeter is greater than (2D+2L) where D is the maximum width of the section and L is the maximum length of the section.

Where the section is a longitudinal section, the length of the perimeter may be at least twenty percent greater than (2D_{A}+2L) where D_{A} is the average width of the section and L is the maximum length of the section. The length of a longitudinal section is measured from the base to the body portion outlet.

The perimeter may be castellated. Castellations increase the surface area of the bottle thereby increasing the boundary layer within the bottle. The greater the volume of boundary layer that exists, the greater the volume of milk which is cooled.

In one embodiment the castellations are adapted to be gripped by an infant. Having gripping portions on the bottle allows for the infants to feed themselves and develop a degree of independence.

The castellations on the section may extend to a depth that which is more than twenty five percent of the maximum width of the section.

The castellations may be vertical. The castellations may be aligned with the bottle axis.

The castellations may extend from a body portion base towards the body portion outlet.

The castellations may extend for seventy-five percent of the height of the bottle measured from the base.

The castellations may taper outwardly from the base.

The castellations may extend from the base to the outlet.

The width of each castellation may increase with the distance from the base. Arrangements such as this facilitate cleaning of the bottle, avoiding the existence of inaccessible pockets at the bottom of the castellations towards the base of the bottle.

Alternatively the castellations may lie parallel to the base.

The castellations may be stacked.

In one embodiment the convoluted perimeter defines a plurality of “U” shapes.

The convoluted perimeter may define a plurality of “∩” shapes.

In one embodiment, the convoluted perimeter may define alternate U and ∩ shapes.

The bottle outlet may be releasably attachable to a closure.

The bottle may further comprise a closure, the closure adapted to be connected to the bottle outlet.

The bottle closure may be releasably connected to the bottle outlet.

The bottle closure may comprise a teat.

The teat may be a soft teat or a more rigid teat like a spout.

In a further alternative embodiment, the bottle closure may be a foil or plastic lid.

The bottle outlet may be reusable.

The bottle outlet may be releasably attachable to the closure by means of a threaded connection.

Alternatively the bottle outlet may be releasably attachable by means of a snap fit, interference fit or adhesive connection.

Where the closure comprises a teat, the closure may further comprise a teat collar adapted to connect the teat to the bottle outlet by means, for example, of a threaded connection.

The body portion may define a base.

The body portion base may define a recess.

The recess may extend into a body portion interior. Providing a recess permits cooling or heating fluid to extend upwardly from the base into the interior of the body portion. This arrangement increases the surface area of the body portion and allows cooling or heating fluid to get to the body of the milk in the bottle.

The body portion may define an outwardly extending bulge.

The bulge may extend outwardly in a direction transverse to the bottle axis.

The bulge may be located adjacent the bottle outlet. A bulge at the top is provided to raise the position of the centre of the gravity such that, in use the bottle is easier for an infant to hold.

The bottle body portion may comprise a polymer.

In a preferred embodiment the body portion comprises a polypropylene random copolymer 203-NA02. This material is preferred as it does not contain bisphenol A, a chemical normally contained in plastics. Bisphenol A has been banned in some countries.

The body portion may be adapted to be injection moulded.

Alternatively the body portion may be adapted to be blow moulded.

In a further alternative, the body portion may be made of an elastomeric material.

The body portion may be invertible. Having a body portion which can be inverted analyse the contents of the bottle to be pressed out if, for example the contents is a food product, and facilitates cleaning.

The bottle axis may be curved.

The bottle may define a base, the base defining at least one surface engaging portion, the/each surface engaging portion lying on a base plane.

The base plane and the bottle outlet plane may be non-parallel. Non-parallel base and bottle outlet planes provide a bottle which is curved. Such a bottle is easier for a baby to hold permitting the baby to feed itself from a younger age.

The body portion may be adapted to engage a bottle support.

The body portion may be adapted to receive a bottle support between adjacent castellations.

According to a second aspect of the present invention there is provided a bottle for feeding an infant, the bottle comprising:
a body portion adapted to be attachable to a feeding teat, the body portion having a base and an interior, the base defining a recess extending into the interior of the bottle;
wherein the recess extends into the interior to a distance equal to at least twenty-five percent of the height of the bottle.

According to a third aspect of the present invention there is provided a bottle for feeding an infant, the bottle comprising:
a body portion having an outlet and a base, the outlet defining an outlet plane and the base defining at least one surface engaging portion, the/each surface engaging portion lying on a base plane;
wherein the outlet plane and the base plane are non-parallel.

According to a fourth aspect of the present invention there is provided an infant feeding system, the system comprising:
a bottle comprising a body portion adapted to be attachable to a feeding teat, the body portion having a longitudinal section which is convoluted; and
a support comprising a base and a plurality of fingers extending upwardly from the base,
wherein each finger is adapted to be received within a portion of a convolution defined by the bottle body portion.

Such an arrangement, in at least one embodiment of the present invention, allows for the body portion to be securely supported by the fingers engaging a convoluted surface. A surface which is convoluted has a greater surface area than a conventional bottle surface and, as such, provides the opportunity for greater surface contact between the support and the bottle.

The body portion may define a convoluted surface.

The body portion surface may define a plurality of recesses.

The support fingers may be adapted to be received within the body portion recesses.

The fingers may be resilient. Resilient fingers can be used to grip the bottle.

The fingers may define a bottle engaging surface which is complementary to a finger receiving surface defined by the bottle body portion. Such an arrangement maximises the surface area in contact when the support and the bottle portion are engaged.

The body portion surface recesses may extend in the same direction as a bottle central axis.

The support may be adapted to be chilled. Being able to chill the support allows the support to be used to assist in cooling down the bottle.

The support may be at least partially hollow.

The support may contain a liquid. The liquid may be freezable in a domestic freezer, for example, to maximise the chilling effect of the support.

The body portion may be adapted to slide onto the support.

The support may be releasably attachable to a surface.

The support may be releasably attachable by means of a sucker. A sucker allows for the support to be securely fixed to a work surface or a pram handle, for example. Alternatively, the support may be releasably attachable by a clamp, tie or other similar connection means.

According to a fifth aspect of the present invention there is provided a support for supporting a feeding bottle for an infant, the support comprising:
a base; and
a plurality of fingers extending upwardly from the base, each finger adapted to engage a recess defined by an infant feeding bottle body portion.

According to a sixth aspect of the present invention there is provided a container for a food product, the container comprising:
a body portion adapted to be sealed by a closure, the body portion having a perimeter around either at least one longitudinal section or at least one transverse section which is convoluted.

In one embodiment the body portion is invertible.

The body portion may comprise an elastomeric material.

It will be understood that preferred or alternative features listed in respect of one aspect of the invention may be equally applicable to other aspects but have not been repeated for brevity.

### BRIEF DESCRIPTION OF THE DRAWINGS

Embodiments of the present invention will now be described in which;

FIG. 1 is a side view of a bottle for feeding an infant according to a first embodiment of the present invention;

FIG. 2 is a side view of the body portion of the bottle of FIG. 1;

FIG. 3 is a transverse section along the line A-A of FIG. 2;

FIG. 4 is a plan view of the body portion of the bottle of FIG. 1;

FIG. 5 is a longitudinal section taken along line B-B of FIG. 4;

FIG. 6 is a plan view of a body portion of a bottle for feeding an infant according to a second embodiment of the present invention;

FIG. 7 is a longitudinal section taken along C-C of FIG. 6;

FIG. 8 is a side view of the body portion of FIG. 6;

FIG. 9 is a transverse section taken along line D-D of FIG. 8;

FIG. 10 is a plan view of the body portion of a bottle for feeding an infant according to a third embodiment of the present invention.

FIG. 11 is a longitudinal section view taken along line E-E of the body portion of FIG. 10.

FIG. 12 is side view of the body portion of FIG. 10;

FIG. 13 is transverse section taken along line F-F on FIG. 12;

FIG. 14 is a longitudinal section of a body portion of a bottle for feeding an infant according to a fourth embodiment of the present invention;

FIG. 15 is a longitudinal section of a body portion of a bottle for feeding an infant according to a fifth embodiment of the present invention;

FIG. 16 is a longitudinal section of a body portion of a bottle for feeding an infant according to a sixth embodiment of the present invention;

FIG. 17 is a side view of a body portion of a bottle for feeding an infant according to a seventh embodiment of the present invention;

FIG. 18 is an end elevation of the body portion of FIG. 17;

FIG. 19 is a plan view of the body portion of FIG. 17;

FIG. 20 is a side view of an infant feeding system according to an eighth embodiment of the present invention;

FIG. 21 is a side view of an infant feeding system according to an ninth embodiment of the present invention;

FIG. 22 is a side view of a container according to a tenth embodiment of the present invention; and

FIG. 23 is a side view of a bottle for feeding an infant according to an eleventh embodiment of the present invention.

### DETAILED DESCRIPTION OF THE DRAWINGS

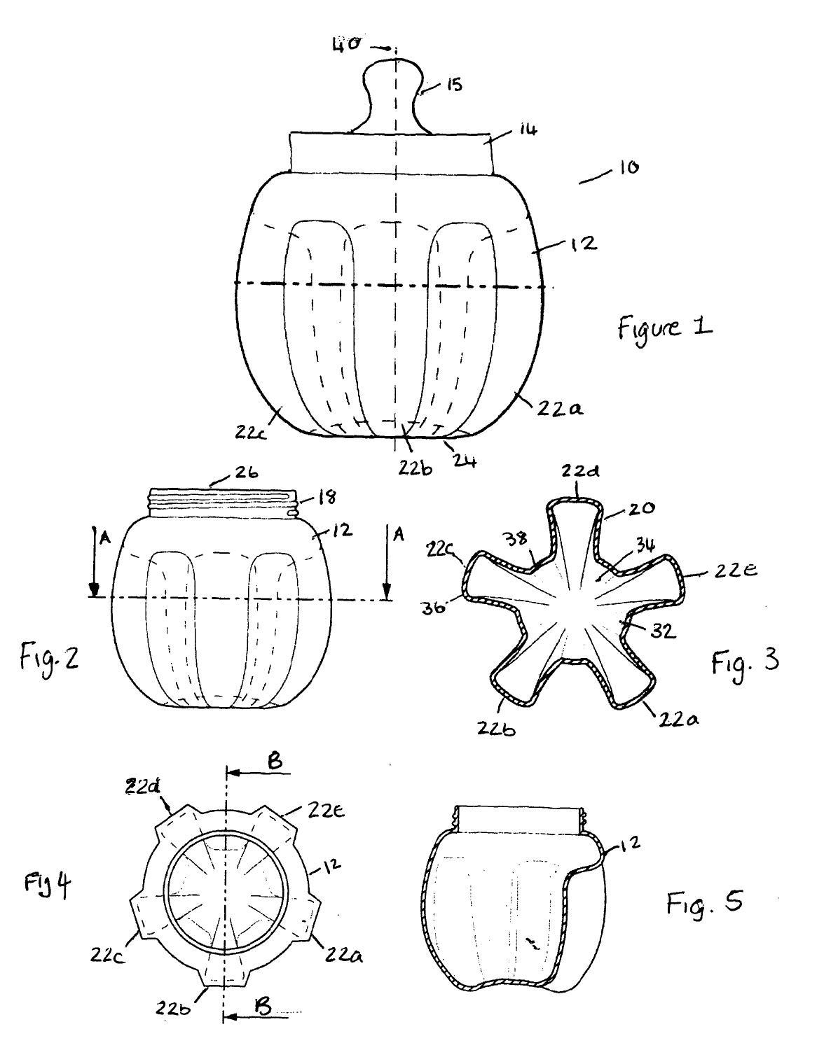

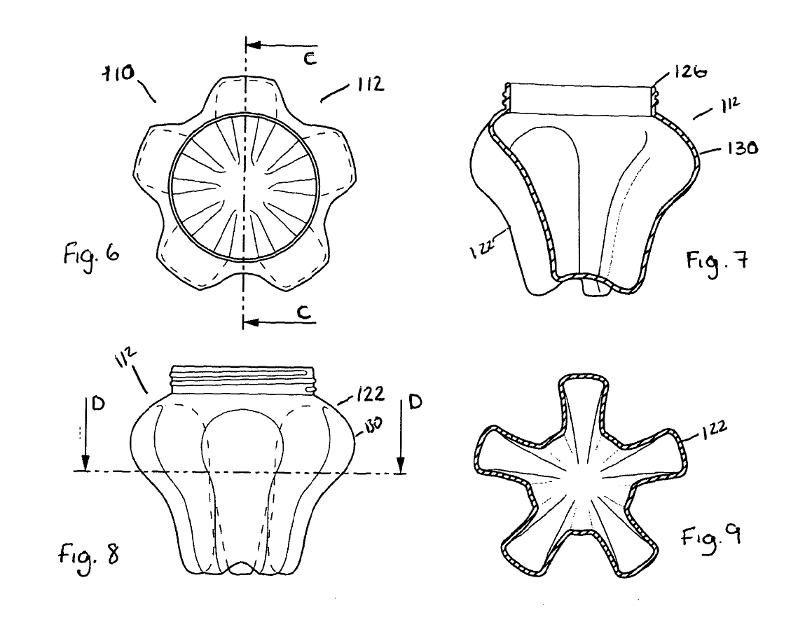

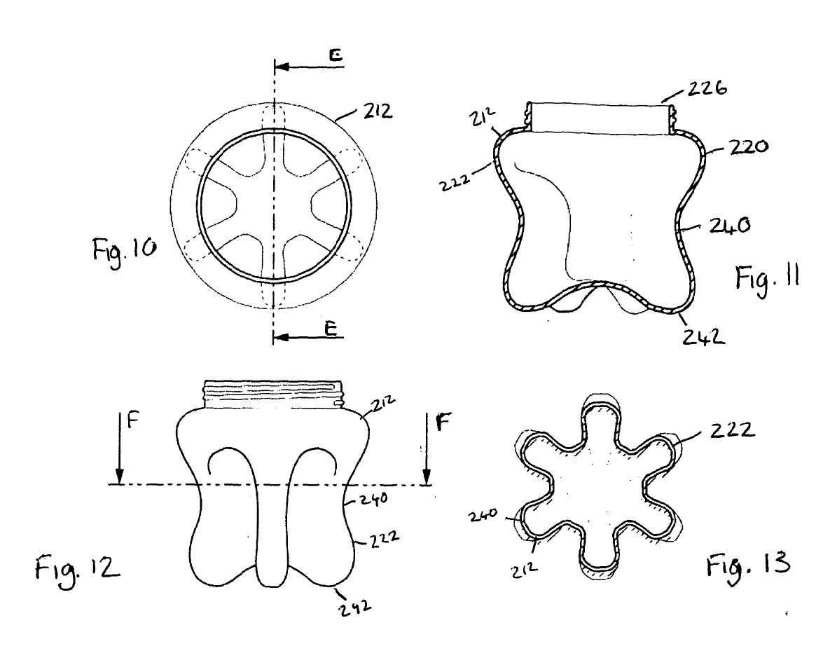

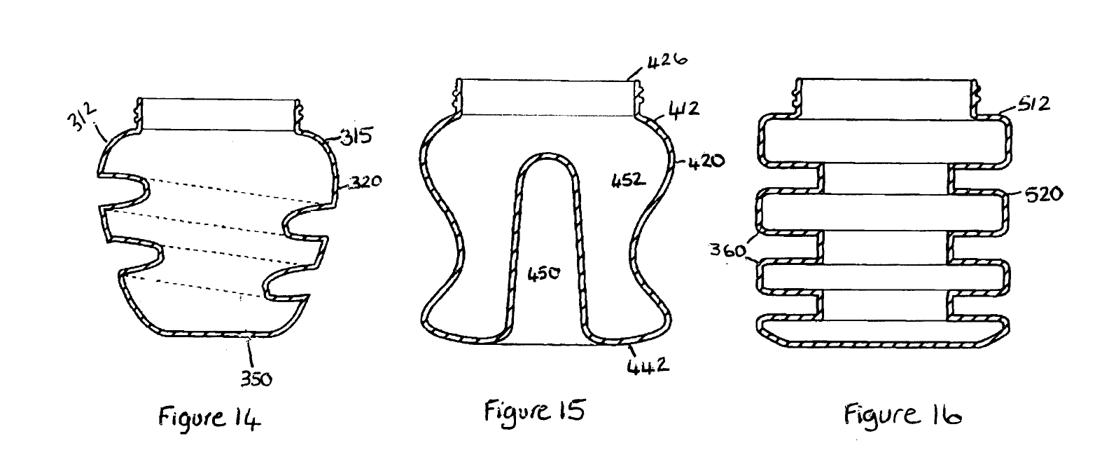

Reference is firstly made to FIGS. 1 to 5 which show various views of a bottle, generally indicated by reference numeral 10 for feeding an infant. The bottle comprises a body portion 12, a collar 14 and a feeding teat 16, the feeding teat 16 being secured to the body portion 12 by collar 14 which forms a threaded connection with a threaded surface 18 defined by the body portion 12. Referring particularly to FIG. 3, a transverse section taken along the line A-A of FIG. 2, it can be seen that the perimeter 2D of the section is convoluted. Particularly the bottle body portion 12 defines five castellations 22a-22e which extend up the body portion 12 in a vertical direction from a body portion base 24 towards the body portion outlet 26.

The use of a castellated surface increases the surface area of the body portion 12 and, as such, increases the size of the surface which is available for a formation of a boundary layer when the bottle 10 is immersed in a liquid which is either hotter or colder than the liquid contained in the bottle 10. When the bottle 10 is initially immersed in the liquid, there will be a heat exchange between the bottle and the surrounding fluid until a position is reached in which a boundary layer is formed and the rate of heat exchange drops off. As can be seen from FIG. 3 the use of a castellated surface increases the size and hence volume of the boundary layer, shown in broken outline and indicated by reference numeral 30, which in turn reduces the volume of fluid which is in the region outwith the boundary layer, indicated by reference numeral 34, providing for an improved cooling or heating effect.

As can be seen from FIG. 3, there are five castellations 22, each castellation comprising a protrusion 36 and a recess 38, each of the protrusions and recesses being ∩ and U shaped respectively.

The section A-A is perpendicular to a bottle axis 40, shown in FIG. 1, which runs through the bottle outlet 26 and the teat 16 and is parallel to the flow of fluid through the teat 16.

The bottle body portion 12 comprises a polypropylene random copolymer 203-NA02. The height of the body portion 12 is approximately equal to the maximum width of the body portion providing a compact shape suitable for gripping by an infant, the castellations 22 providing a surface suitable for gripping.

Referring to FIGS. 6 to 9, there is shown a body portion 112 for an infant feeding bottle (not shown) according to a second embodiment of the present invention. This body portion 12 is similar in many respects to the body portion 12 of FIGS. 1 to 5 however it will be noticed the castellations 122 bulge outwards, defining a bulge 130 adjacent the bottle outlet 126. Incorporating a bulge 130 in this position moves the centre of gravity of the bottle 110 towards the bottle outlet 126. When the bottle 110 is in use the centre of gravity will therefore be closer to the infants mouth making it easier for the user and the infant to hold and manipulate.

Furthermore providing a bulge 130 allows for a large volume of milk to be contained within the bulge 130 permitting the length of the body portion 112 to be reduced such that in use the majority of the body portion 112 would be contained within a user's hand, particularly if the user is an adult feeding an infant.

A further embodiment of the invention is shown in FIGS. 10 to 13 which show a body portion 212 for an infant's feeding bottle (not shown). It will be noted that this body portion 212 has six castellations 222 (best seen in FIG. 13). Referring to FIG. 11, the perimeter 220 of the longitudinal section defines a narrow section 240. This is provided to improve handling of the body portion 212 when used to feed an infant in the prone position. When the infant is prone, the user may find it most convenient to hold the body portion 212 with the body portion base 242 in his palm and allowing his fingers to extend up the sides of the body portion 212 and fit into the narrowed portion 240. This ensures a comfortable and secure grip for the user on the body portion 220.

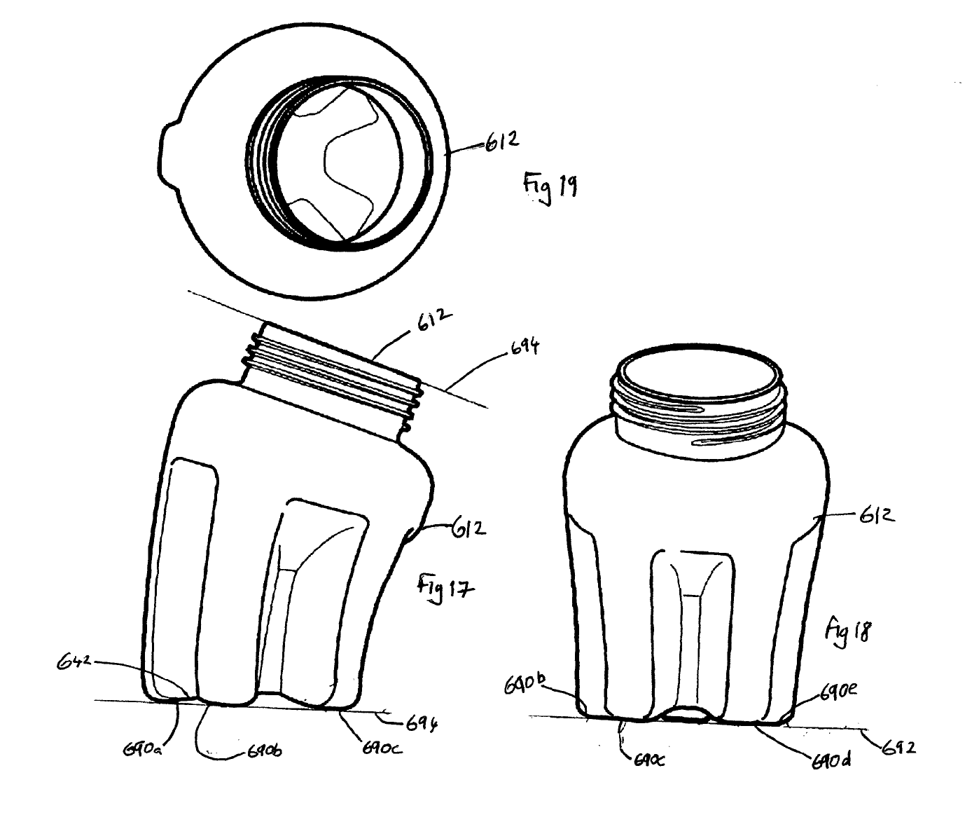

FIGS. 14-16 show longitudinal sections of a body portion 312, 412, 512 of a bottle for feeding an infant according to a fourth, fifth and sixth embodiments of the present invention respectively. These figures show designs of body portions 312, 412, 512 having convoluted perimeters 320, 420, 520 on their longitudinal sections. Again the perimeters 320, 420, 520 comprise adjacent ∩ and U shapes providing an increased surface area which in turn needs to increase boundary layer thicknesses.

The body portion 312 of FIG. 14 defines a spiral recess 350.

Referring to FIG. 15 it will be noted that the body portion base 442 defines a recess 450 which extends upwardly into the interior 452 of the body portion 412. This recess 450 increases the surface area of the body portion 412 and allows cooling or heating fluid to be positioned adjacent the centre of the bottle interior 152. As can be seen from FIG. 15 the recess 450 extends to a height greater than fifty percent of the height of the body portion 412.

The body portion 512 of FIG. 16 defines a plurality of horizontal castellations 360.

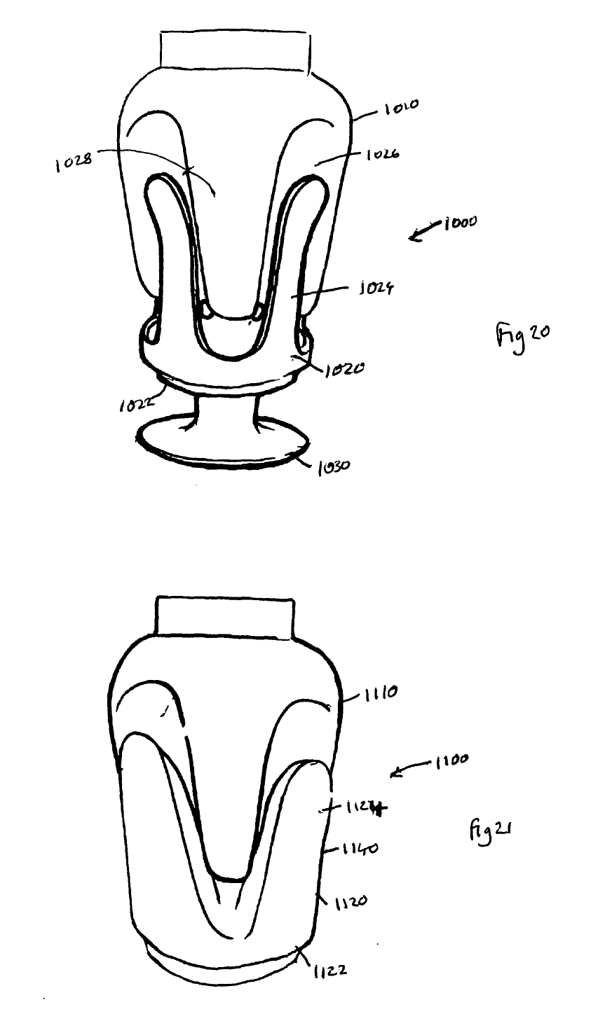

FIGS. 17 to 19 show a body portion 612 of a bottle for feeding an infant according to a seventh embodiment of the present invention. The body portion base 642 defines five surface engaging portions 690 a-e, the surface engaging portions 690 lying on a base plane 692 which is nonparallel with a bottle outlet plane 694. Such an arrangement gives the bottle body portion 612 a curve which facilitates an infant drinking from the assembled bottle.

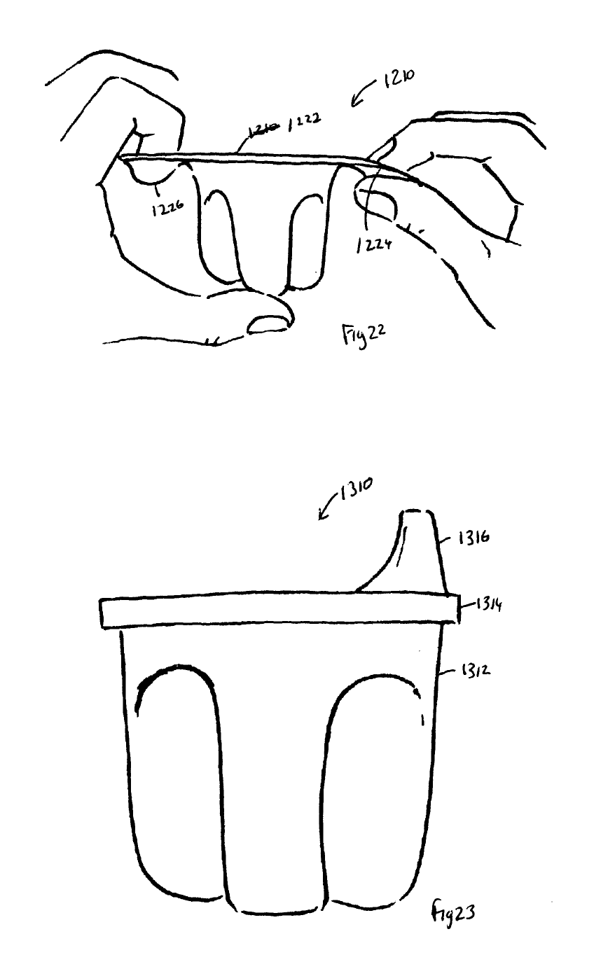

FIG. 20 is a side view of an infant feeding system 1000 according to an eighth embodiment of the present invention. The infant feeding system 1000 comprises a body portion 1010 similar to the body portion 12 of the first embodiment, and a bottle support 1020. The bottle support 1020 comprises a base 1022 and five resilient fingers 1024 each resilient finger adapted to grip the bottle body portion 1010 in the recesses 1026 between adjacent castellations 1028. To secure the body portion 1010 to the support 1020, the body portion 1010 is pressed downwards onto the support 1020 causing the resilient fingers 1024 to move radially outwards. The resiliency within the fingers 1024 gripping the body portion 1010.

The base 1022 is provided with the gripping mechanism 1030 in the form of a sucker to allow the support 1020 to be securely positioned on a surface.

FIG. 21 is a side view of an alternative infant feeding system 1100 according to an ninth embodiment of the present invention. In this embodiment, the support 1120 comprises a hollow housing 1140 which contains a freezable liquid. The freezable liquid fills the entire housing 1140 including up the fingers 1124 and across the base 1122. Such an arrangement facilitates cooling of liquid within the bottle body portion 1110 as mounting it on the support 1120, when the liquid within the support 1120 is frozen, will increase to raise the transfer from the support 1120 to the bottle body portion 1110.

FIG. 22 is a side view of a container 1210 according to a tenth embodiment of the present invention. The container 1210 has an outlet 1212 adapted to be sealed by a foil closure (not shown). The foil closure is removable and the contents of the container 1210 can be removed by turning the container 1210 inside out. The container outlet 1212 includes a gripping portion 1224 and a finger recess 1226 to facilitate inversion, as shown.

FIG. 23 is a side view of a bottle 1310 for feeding an infant according to an eleventh embodiment of the present invention. The bottle 1310 comprises a body portion 1312 similar in many respects to the body portion 12 of FIG. 1, and a lid 1314 attached to the body portion 1312 by a snap fit. The lid 1314 includes a spout 1316 which permits an older infant to drink from the bottle 1310 without spillage.

Various modifications and improvements may be made to the above described embodiments without departing from the scope of the invention. For example the recess shown in FIG. 15 may extend only partially into the interior to a height of, for example, twenty-five percent of the maximum height of the bottle, or may extend up to, and adjacent, the bottle outlet 426.

Although embodiments with five or six vertical castellations are shown, a larger or smaller number of castellations may be provided if required.

1. A bottle for feeding an infant, the bottle comprising:
a body portion adapted to be attachable to a feeding teat or spout, the body portion having a perimeter around at least one transverse section which is convoluted and the body portion defining an outlet, wherein the perimeter is castellated having castellations that extend from a body portion base towards the body portion outlet.

2-3. (canceled)

4. The bottle of claim 1, wherein the height of the bottle is no more than fifty percent bigger or smaller than the maximum width of the bottle.

5. (canceled)

6. The bottle of claim 1, wherein the distance of any given point on the section from the section perimeter is less than fifty percent of the maximum width of the section.

7. The bottle of claim 1, wherein the distance of any given point on the section from the section perimeter is less than thirty percent of the maximum width of the section.

8. The bottle of claim 1, wherein, where the section is a transverse section, the length of the perimeter is greater than (πD) where D is the maximum width of the section.

9-12. (canceled)

13. The bottle of claim 1, wherein the castellations on the section extend to a depth that which is more than twenty five percent of the maximum width of the section.

14. The bottle of claim 1, wherein the castellations are vertical, the castellations being aligned with the bottle axis.

15. (canceled)

16. The bottle of claim 1, wherein the castellations extend for seventy-five percent of the height of the bottle measured from the base.

17. The bottle of claim 1, wherein the castellations extend from the base to the outlet.

18. The bottle of claim 1, wherein the castellations taper outwardly from the base.

19. The bottle of claim 1, wherein the width of each castellation may increase with the distance from the base.

20-21. (canceled)

22. The bottle of claim 1, wherein the convoluted perimeter defines a plurality of “U” shapes.

23. (canceled)

24. The bottle of claim 1, wherein the convoluted perimeter defines alternate U and ∩ shapes.

25-26. (canceled)

27. The bottle of claim 1, wherein the body portion defines a base, the base defining a recess.

28-32. (canceled)

33. The bottle of the claim 1, wherein the body portion is adapted to engage a bottle support and to receive a bottle support between adjacent castellations.

34-50. (canceled)

51. A container for a food product, the container comprising:
a body portion adapted to be sealed by a closure, the body portion having a perimeter around either at least one longitudinal section or at least one transverse section which is convoluted.

52. The container of claim 51, wherein the body portion is invertible.

53. The container of claim 51, wherein the body portion comprises an elastomeric material.

54. The bottle of claim 33, wherein the bottle support is at least partially hollow and contains a liquid which is chillable whereby it is used to assist in cooling down the bottle.

55. The bottle of claim 1, which comprises 5 or fewer castellations.
